(19) United States
(12) Patent Application Publication
(10) Pub. No.: US 2003/0140536 A1
(43) Pub. Date: Jul. 31, 2003

(54) Illuminated display device

(76) Inventor: David R. Bilyeu, McDonald, TN (US)

Correspondence Address: VAN DYKE & ASSOCIATES, P.A., 7200 LAKE ELLENOR DRIVE, SUITE 252, ORLANDO, FL, 32809, US

(21) Appl. No.: 10/318,287

(22) Filed: Dec. 11, 2002

Related U.S. Application Data
(60) Provisional application No. 60/339,840, filed on Dec. 11, 2001.
(60) Provisional application No. 60/384,069, filed on May 29, 2002.

(51) Int. Cl. G09F 13/04

(52) U.S. Cl. 40/574; 40/578; 40/597; 40/591

(57) ABSTRACT

An illumination device for a variety of commercial purposes that displays a message, logo or advertisement. The illumination device preferably includes a housing having a front component includes a transparent portion, a panel, a sealing means, and an outer edge, a back component which is removably connected to the front component, a connector, a light source, and a power source such a solar power assembly.

### CROSS-REFERENCE TO RELATED APPLICATIONS

This application claims priority to U.S. Provisional Application Serial No. 60/339,840, filed on Dec. 11, 2001 and U.S. Provisional Application Serial No. 60/384,069 filed on May 29, 2002, 35 USC § 119(e). The entire disclosures of these applications are hereby incorporated by reference.

### FIELD OF THE INVENTION

The present invention relates to an illumination display device for a variety of commercial products which includes a solar power assembly. More specifically, an illumination display device having a high gloss view during the daylight hours and illuminates a logo and/or advertisement during the nighttime hours.

### BACKGROUND OF THE INVENTION

Vehicles have long been used in advertising a variety of commercial products in the form of logos, messages, characters, signs, and sports memorabilia. For example, aircrafts are used to drag banners through the sky, taxis mount illumination devices on their roof tops, and semi-trucks use the sides of their tractor trailers to display billboard like signs promoting a business or message.

U.S. Pat. No. 4,109,245 issued on Aug. 22, 1978 discloses a programmable electronic sign having a set of segmented character displays which include programming cards used to control which segments are illuminated. U.S. Pat. No. 4,361,828 issued on Nov. 30, 1982 to Wanda H. Hose teaches an automotive communication system device having an optical-electrical message display unit adapted to be viewed from the exterior of a vehicle. The message control unit is connected to the display unit for programming a message and transmitting an electrical pulse pattern to the display unit which causes the display unit to display the programmed message.

U.S. Pat. No. 4,574,269 issued on Mar. 4, 1986 to Gregory R. Miller teaches a visual communicator for a rear window of a vehicle. The communicator is semi-transparent and includes a message display unit having a plurality of light emitting diodes comprising a matrix arrangement. The patent also includes a message control unit operationally interconnected to the diodes.

It is well known that the temperature inside any vehicle can reach extreme hot temperatures caused by the sun during the daytime or extreme cold temperatures caused at nighttime during cold winter months. The problem with electronic signs and display units described above is that the computerized parts such as memory cards and control units used in these devices get damaged when subjected to extreme temperatures.

U.S. Pat. No. 4,276,705 issued on Jun. 7, 1981 to Barth et al., illustrates a graphical display apparatus having an enclosure and a thin opaque cover made up of an outermost sheet bearing a design. The apparatus also includes an underlying sheet of aluminum foil and an aluminum screen. Incandescent lights are mounted within the enclosure to light its interior. The use of pointed markers made of transparent plastic along with the incandescent lights illuminates a design. These markers are pushed through the display sheet that bears the design. This apparatus is not designed for a vehicle, but functions as a communication device for displaying locations on a map.

U.S. Pat. No. 4,860,478 issued on Aug. 29, 1989 to Tony R. Hall describes an automobile display device having a housing, a perforated display board, and a plurality of light transmitting indicia elements inserted into the perforation of the display board. This patent and U.S. Pat. No. 4,276,705 have a similar idea of displaying a map or design through markers and perforations.

U.S. Pat. No. 4,470,214 issued on Sep. 11, 1984 to Clary M. Kinloch discusses a display sign for the rear window of a vehicle or a bumper that displays different posters which reflect light from their faces. The sign consists of a box with a light that shines on a reflective face of a removable poster and includes a folding frame that receives one poster at a time.

U.S. Pat. No. 4,449,167 issued on May 15, 1984 to Robert Cohen describes an adjustable vehicle safety rear light assembly that is adhesively mountable on the rear window of a car or truck. The assembly can be adjusted along a horizontal axis to be parallel to the road. The assembly includes a lightable area which will illuminate in response to and signal vehicle actions. The assembly also includes a pivoting means on either end of the lightable area and mounting bracket having two dependent sides and a foot perpendicular to each of the sides. Both U.S. Pat. Nos. 4,449,167 and 4,361,828 have potential safety issues with this device because it is very bulky and can block a substantial portion of a driver's view.

U.S. Pat. No. 4,671,004 issued on Jun. 9, 1987 to Marlin C. Berg teaches a vehicle portable sign which is design to mount on the roof-top of a vehicle such as a taxi or delivery vehicle. The portable sign has a hollow body with three side walls, a top wall and a bottom wall interconnected to form a triangle. Suction cups are mounted on the bottom wall as well as strap members to secure the sign of the roof-top of the vehicle. Detachable cover members carrying printed indicia are attachable on the side walls. The illumination source is housed within the body.

U.S. Pat. No. 4,787,163 issued on Nov. 29, 1988 also to Marlin C. Berg describes a vehicle mounted sign removable from the roof-top of a vehicle which includes the same features as the previous patent. However, this patent also includes an alarm system to prevent the unauthorized removal of the sign.

Although this patent solves the problem of the driver's view being blocked and is resistant to extreme temperatures; aesthetically, the portable sign is bulky and unattractive. When the signs are removed from the vehicle's roof-top, a potential change in the color of the paint caused by the sun, damages the appearance of the vehicle.

U.S. Pat. No. 6,178,677 issued on Jan. 30, 2001 to Frederick A. Williams teaches a vehicle-mounted, rear-directed message display apparatus including a housing having a transparent rear wall, a front wall, side walls, a bottom wall, and a cover. Support assemblies are connected to the side walls and extend downwards. An illumination lamp is in the housing near the front wall and a display sign is supported inside the housing between the illumination lamp and rear wall. The display sign is to warn another driver if they are following too closely. This patent involves a complex support assembly including cylindrical riser members, support base plates, struts, and brackets too keep the apparatus in place.

U.S. Pat. No. 5,099,594 issued on Mar. 31, 1992 to John H. Reas discusses a dry-erase message board attached to the window of a vehicle with suction cups and interposed hook and loop fasteners. U.S. Pat. No. 6,046,401 issued on Apr. 4, 2000 to Joseph Christopher McCabe discusses a display device integrated into a photovoltaic panel adapted to simultaneously produce and operate a display. Light passes through openings in photovoltaic material.

U.S. Pat. No. 6,220,737 issued on Apr. 24, 2001 to Michael F. Baragona discloses a vehicle illumination device positioned on the outside of a vehicle for projecting an image onto a surface in the darkness. This image is projected onto the surface of a road or on the side of a vehicle. The apparatus includes a body with first and second ends, whereby the first end houses an illumination device. The second end contains a lens that is aligned with the illumination device. A template is positioned between the first and second end which contains the image.

Two problems that are associated with this device is first, the lens being on the outside of the vehicle can get an accumulation of bug splatters which would distort any image the lens is trying to project. Secondly, the device could be easily stolen off the vehicle when the vehicle is unattended by the driver. One major problem with illumination devices located on a vehicle is at night when the light source is activated, the glare from the window or the light source itself can obstruct a driver's view which is a major safety issue.

An ideal illumination device could be easily displayed in the inside of a vehicle and not contain computerized parts that would get damaged when subjected to extreme temperatures. An energy efficient illumination device would be solar powered and may contain rechargeable batteries for night illumination. The device would be large enough for passing vehicles and onlookers to view, but not too large where the illumination device would impair the view of the driver. The ideal illumination device would not throw off a glare either via the light source or by the reflection or refraction from the light off the window.

### SUMMARY OF THE INVENTION

The present invention relates to an illumination device for a variety of commercial related products which display an illuminated message, logo, or advertisement in the form of signs, ornaments, characters, sports memorabilia and is powered by at least one solar panel assembly. The first embodiment of the illumination device comprises a housing having a front and back component which is can be removably connected to each other or permanently attached. The front component includes a panel having a non-transparent portion and a transparent portion in the form of indicia to be illuminated. The front component may additionally include an outer frame component which is dimensioned and configured appropriately for its intended commercial purpose preferably, but not limited to a license plate, and a plurality of shaped frames for surrounding the indicia. The illumination device comprises an attachment means. Any attachment means which is standard in the art can be utilized by the present invention. One such attachment means include a plurality of suction cups extending from the front component for attaching the illumination device to a surface. However, some illumination devices, for example, a solar powered illumination license plate is attached by methods generally known to one skill in the art of attaching illumination devices such as screws, double stick tape, mountable bracket(s), or magnets to name a few. The illumination device further comprises a light source either included in the housing or in the power source which is connected to the light source to provide electricity for illumination. The power source is preferably generated at least one solar power with rechargeable backup batteries, or the vehicles' own generated electrical power or any combination thereof. In the first aspect of the first embodiment, the outer edges of the front component includes a sealing means to prevent interior illumination of the vehicle. In a second aspect of the first embodiment the solar panel further comprises a lens with a slight angle to allow for light to project upwards and inwards to illuminate its potential target. The solar panel assembly in the third aspect of the first embodiment is connected or mounted on the back component of the housing. In a second embodiment, the illumination device can be attached to an antenna by mountable brackets. In a third embodiment, the illumination device includes a solar panel mounted on the top of the housing and angled to receive the most exposure to sunlight. The configuration of the solar panel in this embodiment can be in any shape, form or angle depending on the application and commercial purpose of the illumination device. A fourth embodiment of the present invention comprises a solar powered assembly including at least one solar panel, rechargeable batteries, and a light source for mounting on a sign, billboard or address so that the light source in the solar powered assembly illuminates the information of the above. All embodiments are solar powered through at least one solar panel angled to receive the most exposure to sunlight. Most embodiments of the present invention include rechargeable batteries within or near the solar panel.

It is an object of the present invention to provide an illumination device for a variety of commercial purposes to display a desired message, logo, or advertisement in the form of signs, ornaments, characters, sports memorabilia.

It is another object of the present invention to provide an illumination device that includes a sealing means when can be removably attached to the inside and/or outside of a window of a vehicle to prevent interior illumination which can interfere with the driver's view.

It is a further object of the present invention to provide an illumination device for a vehicle that is small enough not to block the driver's view, yet large enough for passing vehicles to see the indicia and can be attached to the antenna, license plate section, vehicle window.

It is still a further object of the present invention to provide a removably illumination device for illuminating commercial signs which includes a solar panel, rechargeable batteries, and a light source which is mounted onto an already existing sign or is supplied with a commercial sign or billboard.

It is still another further object of the present invention to provide an illumination device that is economical, energy efficient, and light in weight.

The foregoing has outlined some of the more pertinent objectives of the present invention. These objectives should be construed to be merely illustrative of some of the more prominent features and applications of the invention. Many other beneficial results can be attained by applying the disclosed invention in a different manner of modifying the invention as will be described.

It is to be understood that the foregoing general description and the following detailed description are exemplary and explanatory only and are not to be viewed as being restrictive of the present, as claimed. These and other objects, features and advantages of the present invention will become apparent after a review of the following detailed description of the disclosed embodiments and the appended claims.

### DESCRIPTION OF THE DRAWINGS

FIG. 1 shows a perspective view of an embodiment of the invention mounted in the rear window of a car.

FIG. 2 shows a side view of an embodiment of the invention (FIGS. 2A&B).

FIG. 3 shows a side view of an embodiment of the invention including a circuit switch (FIG. 3A), including a solar panel in the shape of an outer frame (FIGS. 3B&C).

FIG. 4 shows a side view of an aspect of the first embodiment of the illumination device where the solar panel including a lens.

FIG. 5 shows a side view of another aspect of the first embodiment of the illumination device where the back component includes the solar panel assembly.

FIG. 6 shows a side view of the second embodiment of the illumination device whereby the device can be attached to an antenna and the solar panel assembly is at the top of the housing (FIG. 6A) and at any angle (FIG. 6B).

FIG. 7 shows a side view of the third embodiment of the illumination device displaying a vertically angled solar panel assembly in or in the shape of the hat.

FIG. 8 shows a side view of the fourth embodiment of the illumination device illustrating the solar panel assembly (FIG. 8A) or in use illuminating a commercial sign (FIG. 8B).

### DESCRIPTION OF THE PREFERRED EMBODIMENTS

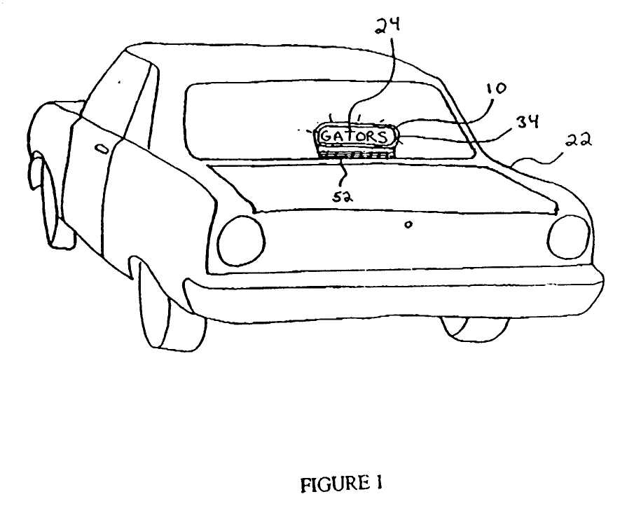

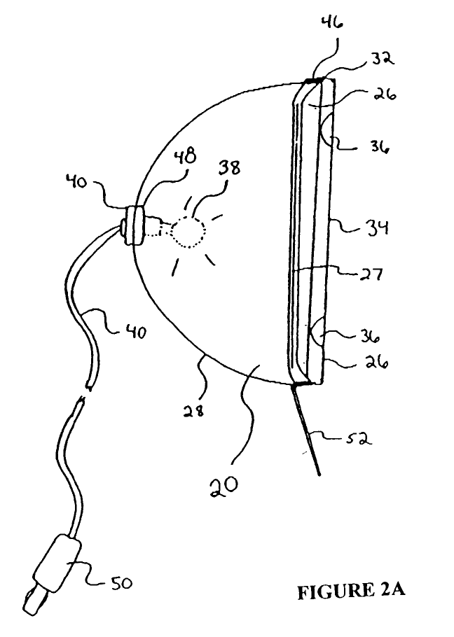

The present invention is an illumination device 10 for a vehicle 22 to display a message, logo or advertisement 24 shown in FIG. 1. The first embodiment 10 illustrated in FIG. 2., depicts a removable illumination device 10 including a housing having a top section 23, a bottom section 25, a front component 26, a removable panel, and a back component 28, a solar power assembly 52. The housing can be dimensioned and configured to any shape or form. The panel 27 would be dimensioned and configured to be removably connected to the back component 28. The panel 27 in the housing preferably includes a portion 24 which includes a high gloss surface in the form of indicia for viewing during the daylight hours and is illuminated at night by the light assembly which is shown in FIG. 1.

FIGS. 1 and 2A illustrate that the preferred method of removing the panel 27 would include a removable connection means such as a slotted regions 46 that permits the panel 27 to be slideably removed within to exchange one panel 27 for another. The removable connection of the panel 27 is removable by many methods that are known in the art and can be incorporated into the present invention. In the second embodiment 20 illustrated in FIG. 2A, show the front component 26 including an outer edge 32 to which a sealing means 34 is attached to prevent interior illumination that might block a driver's view. Preferably, the sealing means 34 is constructed of materials including, but not limited to, rubber, rubber-like, foam, and plastic. FIG. 2B shows an embodiment 20 having a solar power assembly 52 that does not include a sealing means and may include a removable panel or a permanent panel 27.

The present invention 20 also includes a plurality of suction cups 36 extending from the front component 26 of the housing for the attachment of the device to a surface. The suction cups 36 would be attached to the front component 26 or edges 32 of the front component 26 in a way that they would not interfere with the illumination of the indicia. The suction cups 36 are to be attached to a suitable surface, preferably on the inside of a vehicle 22 window. The back component 28 is preferably made from injected molden plastic; however, any lightweight temperature resistant material will suffice. The back component 28 can be constructed of materials in order to provide an illumination device 20 that is both economical and light in weight. The illumination device 20 includes a light source 38 which is dimensioned and configured to attach within the back component 28 of the housing.

A power source 40 is connected to the light source 38 to provide electricity for illumination. The light source 38 is preferably, but not limited to, a light bulb assembly 48 or an incandescent light assembly. The power source 40 of the present invention is preferably from a small solar power assembly 52 or from a solar power assembly 52 in combination with a battery 44 which is included as part of the illumination device 10. Either the battery 44 is replaceable or is rechargeable by a battery charger or recharged by the solar power assembly 52 during the day while the vehicle is parked in sunlight. The solar power assembly 52 is pivotably attached or angled onto the housing for adjustment to maximize the exposure of the cells within the solar power assembly 52. A Standard pivotably means known on the art for attaching and permitting the solar power assembly 52 to be tilt or moved toward sunlight can be incorporated into the present invention. The power source 40 can also be through a connection to a cigarette lighter 50, a battery 44, and/or small solar panel assembly 52. However, the present invention 10 is not limited to these power sources 40. The illumination device 10 could be wired directly into the vehicles' 22 electrical circuitry or system instead of a small battery.

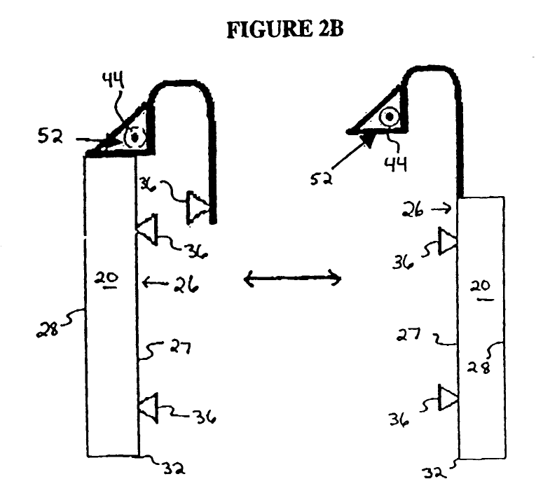

FIGS. 3A-C illustrate the removable illumination devices 10 further including a circuit switch 42 (FIG. 3A) adapted to turn the light source on and off, and/or even the solar power assembly 52 when the device 10 illuminates in response to darkness, especially if the device 10 is operating in combination with small batteries 44. The front component 26 can be removeably attached to the back component 28 preferably, but not limited to, slotted regions, a snap-like attachment, magnetic attachment, clasps, clamps, or interlocking male/female threaded ends 46.

The front component 26 of the housing is transparent to permit the illumination effect of the desired indicia. The panel 26 is constructed to replace films and other types of backgrounds that contain a design or indicia. The indicia on the panel 26 can include, but is not limited to, a message, logo, advertisement, symbols, digits, and other characters. The illumination device 10 is especially good for sporting events; for example, a sporting event on a college campus. The solar panel assembly in FIGS. 3B&C are displayed in the form of an outer frame 51 and are dimensioned and configured appropriately for its intended commercial purpose, preferably, but not limited to a license plate frame, picture frame, or ornamental frame. This aspect of the present invention includes all or any of the combination of elements (not shown) in the first embodiment 10; however, the connector 49 may vary depending on the intended use of the illumination device 10. For example, an illuminated license plate would be attached by screws, mounting taped, or brackets (FIG. 3C), whereas the housing elements 28, 26, 27, of the illumination device 10 is in the picture frame could be mounted on a smooth surface such as a window with suction cups 36 (FIG. 3B).

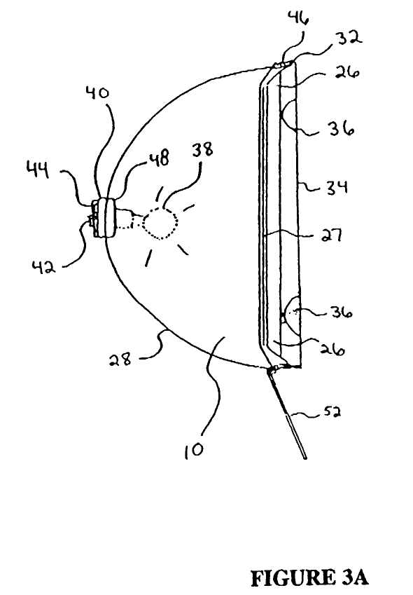

FIG. 4 illustrates the second aspect of the first embodiment 10 whereby the solar panel assembly 52 further comprises a lens 55 with a slight angle to allow for light to project upwards and inwards to illuminate its potential target. This aspect of the first embodiment 10 may comprise only of the solar panel assembly 52 which includes the light source (not shown), rechargeable batteries 44, solar panel, lens 55, and connector (not shown); or this aspect may include all elements or a combination thereof of the housing 26, 27, 28 as described in the first embodiment 10.

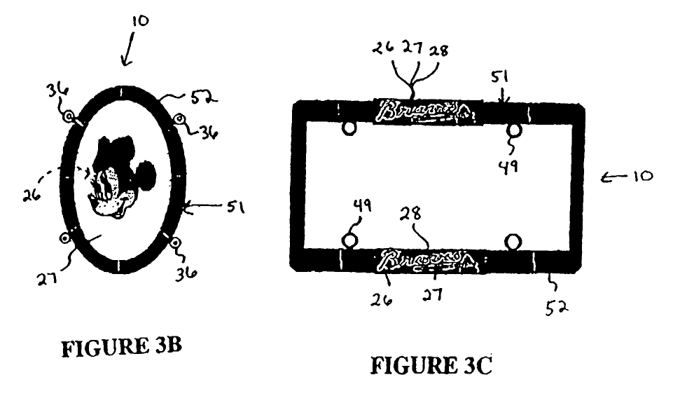

FIG. 5 shows another embodiment of the subject illumination device 10 whereby the solar panel assembly 52 is connected or mounted on the back component 28 of the housing instead of the front component 26. This aspect comprises all the elements of the first embodiment shown in FIG. 5 or a combination thereof with the exception of the placement of the solar panel assembly 52 and the connector (not shown) being mounted or connected to the back component 28. This aspect is constructed whereby the illumination device 10 mounts to the inside window so that the solar panel assembly 52 (solar panel, rechargeable batteries 44 and its housing) faces the exterior of a home or office window.

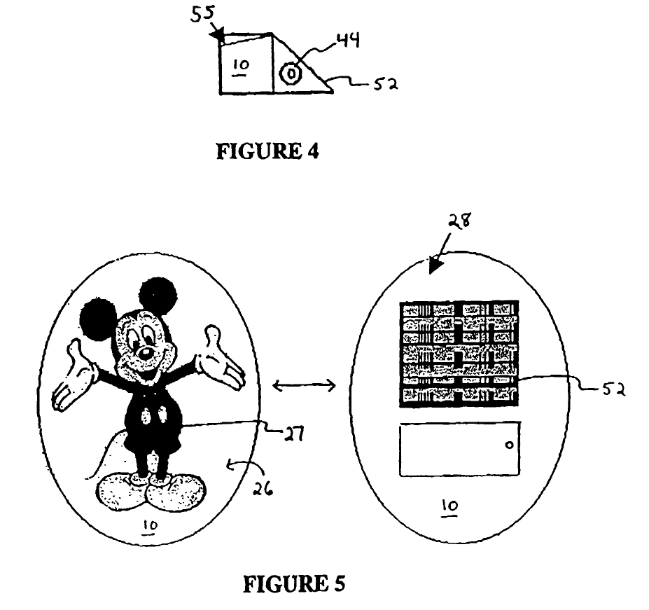

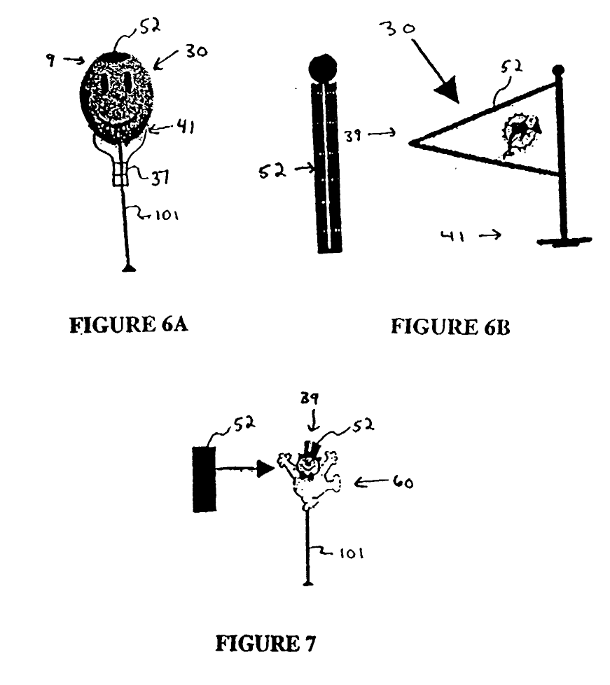

In a further embodiment shown in FIGS. 6A&B, the illumination device 30 can be attached to an antenna 101 by mountable brackets 37 on the bottom section 41 of the housing. The housing in this embodiment 30 can be in the shape of, but not limited to, characters, signs, logos, ornamental, advertising and sports memorabilia, flags, and holiday related products to list a few. The top section 39 of the housing would include the solar panel assembly 52 which may be dimensioned and configured into any shape or size depending on the shape and size of the housing. This embodiment 30 and other embodiments may further include a locking mechanism and mounting bracket 37 to prevent the illumination devices from theft. The housing in many of these embodiments may be open or closed depending on the shape and purpose of the illumination devices. The light source (not shown) is inside the housing which is connected to the solar panel assembly 52. In an alternative embodiment 60 shown in FIG. 7, the illumination device includes a solar panel assembly 52 mounted on the top section 39 of the housing and angled to receive the most exposure to sunlight. The configuration of the solar panel assembly 52 in this embodiment 60 can be in any shape, form or angle depending on the application and commercial purpose of the illumination device. For example, the solar panel assembly 52 is mounted on the housing which is shaped in the form of a flag. Also, the placement of the solar panel assembly may be positioned anywhere on the device 30.

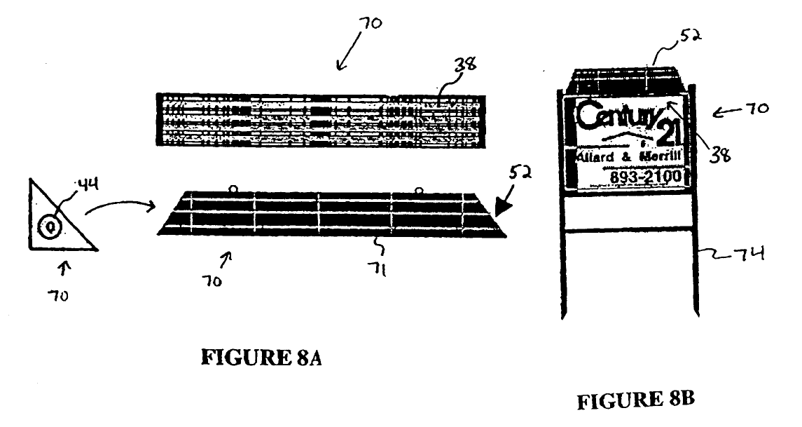

Another embodiment 70 of the present invention shown in FIGS. 8A&B comprise a solar powered assembly 52 which includes at least one solar panel 71, rechargeable batteries 44, and a light source 38 for mounting on a sign 74, billboard or address so that the light source in the solar powered assembly 52 illuminates the targeted information. The light source 38 this embodiment 70 can be configured to illuminate targeted information directed above the solar panel(s) 71 or directed below the solar panel(s) 71. All embodiments are solar powered through at least one solar panel angled to receive the most exposure to sunlight and the light source can be any light source commercially available in different sizes, shapes, and colors. Most embodiments of the present invention include rechargeable batteries within or near the solar panel.

It should be understood, of course, that the foregoing relates only to preferred embodiments of the present invention 10 and 20 and that numerous modifications or alterations may be made therein without departing from the spirit and the scope of the invention as set forth in the appended claims.

What is claimed is:

1. A removable illumination device that displays, comprising:
a housing having a front component, a removable panel, and a back component, said front component is connected to said back component, said front component having an outer edge, said panel includes indicia which is to be illuminated, said panel is removed by a removable connector means, said front component of said housing including a transparent portion to permit said indicia on said panel to be illuminated therethrough;
a plurality of suction cups extending from said front component of said housing for the attachment to a suitable surface;
a light source for illuminating indicia on said panel, said back component of said housing being dimensioned and configured to receive said light source; and
a power source, said power source connected to said light source to provide electricity for illumination.

2. The removable illumination device in claim 1, wherein said power source is selected from the group consisting of a connection to a cigarette lighter, a battery, and small solar panel assembly, or any combination thereof.

3. The removable illumination device in claim 1, wherein said power source is a solar power assembly.

4. The removable illumination device in claim 3, wherein said solar power assembly can be pivoted into alternative positions subjecting the cells of said solar power assembly to the best angle of light.

5. The removable illumination device in claim 2, wherein said power source is powered by a combination of a solar power assembly and at one rechargeable battery.

6. The removable illumination device in claim 5, wherein said solar power assembly can be pivoted into alternative positions subjecting cells of said solar power assembly to the best angle of light.

7. The removable illumination device in claim 1, further comprising a sealing means attached to said outer edge of said front component of said housing for the prevention of interior illumination.

8. The removable illumination device in claim 7, wherein said sealing means which is constructed and selected from the group consisting of rubber, rubber-like, foam, and plastic.

9. The removable illumination device in claim 1, further comprising a circuit switch adapted to turn said light source on and off.

10. The removable illumination device in claim 1, wherein said indicia on said panel includes a high gloss view during the daylight hours and said indicia is selected from the group consisting of a message, logo, advertisement, symbols, digits, and characters.

11. The removable illumination device in claim 1, wherein said front component and said back component of said housing includes a removable connection means selected from of the group consisting of a snap-like attachment, magnetic attachment, clasps, clamps, interlocking male/female threaded ends, and slotted.

12. The removable illumination device in claim 1, wherein said light source is selected from the group consisting of a light bulb assembly or an incandescent light assembly.

13. A removable illumination device that displays, comprising:
a housing having a front component, a removable panel, and a back component, said front component is connected to said back component, said front component having an outer edge, said panel includes indicia which is to be illuminated, said panel is removed by a removable connection means, said front component of said housing including a transparent portion to permit said indicia on said panel to be illuminated therethrough;
a plurality of suction cups extending from said front component of said housing for the attachment to a suitable surface;
a light source for illuminating said panel, said back component of said housing being dimensioned and configured to receive said light source; and
a power source, said power source includes a solar power assembly or a battery source or a combination thereof, wherein said solar power assembly is pivotably attached to said housing, wherein said solar power assembly can be pivoted into alternative positions subjecting cells of said solar power assembly to the best angle of light; said power source connected to said light source to provide electricity for illumination.

14. The removable illumination device in claim 13, wherein said sealing means is constructed and selected from the group consisting of rubber, rubber-like, foam, and plastic.

15. The removable illumination device in claim 13, further comprising a circuit switch adapted to turn said light source on and off.

16. The removable illumination device in claim 13, wherein said indicia on said panel includes a high gloss view during the daylight hours and said indicia is selected from the group consisting of a message, logo, advertisement, symbols, digits, and characters.

17. The removable illumination device in claim 13, wherein said front component and said back component further includes a removable connection means selected from of the group consisting of a snap-like attachment, magnetic attachment, clasps, clamps, and interlocking male/female threaded ends.

18. The removable illumination device in claim 13, wherein said front component of said housing is transparent to permit said indicia on said panel to be illuminated.

19. The removable illumination device in claim 13, wherein said light source is selected from the group consisting of a light bulb assembly or an incandescent light assembly.

20. The removable illumination device in claim 13, wherein said power source is alternatively selected from the group consisting of a connection to a cigarette lighter, a battery, and small solar panel assembly or any combination thereof.

21. A removable illumination device
a housing having a top section, bottom section, front component, a panel, and a back component, said front component is connected to said back component, said front component having an outer edge, said panel includes indicia which is to be illuminated, said front component of said housing including a transparent portion to permit said indicia on said panel to be illuminated therethrough;
at least one connector extending from said front component of said housing for the attachment to a suitable surface;
a light source for illuminating indicia on said panel; and
a power source, said power source is a solar panel assembly and said power source is connected to said light source to provide electricity for illumination.

22. The illumination device in claim 21, wherein said power source is powered by a combination of a solar power assembly and at least one rechargeable battery.

23. The illumination device in claim 21, wherein said solar power assembly further comprises a lens with a slight angle to allow for light to project upwards or inwards to illuminate its potential target.

24. The illumination device in claim 21, wherein said front component further comprises an outer frame.

25. The illumination device in claim 24, wherein said outer frame is a solar panel assembly.

26. The illumination device in claim 21, wherein said solar panel assembly includes at least one rechargeable battery within said assembly.

27. The illumination device in claim 21, wherein said housing is a unitary structure.

28. The illumination device in claim 21, wherein each said connector is selected from the group consisting of suction cups, screws, mounting brackets, and tape, or any combination thereof.

29. The illumination device in claim 21, wherein said housing further comprises a locking mechanism to prevent the device from theft.

30. The illumination device in claim 21, wherein said solar panel assembly is connected to the top section of said housing.

31. The illumination device in claim 1 and 28, wherein said bottom section further comprises at least one said mounting bracket.

32. The illumination device in claim 31, wherein said device is attachable to an antenna.

33. The illumination device in claim 30, said solar panel at said top section is dimensioned and configured into any shape, size or angle.

34. A removable illumination device comprising of a solar panel structure assembly including at least one solar panel, at least one rechargeable battery within said solar panel structure, and at least one light source.

35. The illumination device in claim 34, wherein said further comprises a lens with a slight angle to allow for light to project upwards or inwards to illuminate its potential target.

36. The illumination device in claim 34, wherein said device further comprises at least one attachment means selected from the group consisting of suction cups, screws, mounting brackets, and tape, or any combination thereof.

37. The illumination device in claim 34, wherein said device is connected to a housing having a top section, bottom section, front component, a panel, and a back component, said front component is connected to said back component, said front component having an outer edge, said panel includes indicia which is to be illuminated, said front component of said housing including a transparent portion to permit said indicia on said panel to be illuminated therethrough.
